(19) United States
(12) Patent Application Publication
(10) Pub. No.: US 2025/0370275 A1
(43) Pub. Date: Dec. 4, 2025

(54) AIR FLOATING VIDEO DISPLAY APPARATUS

(71) Applicant: Maxell, Ltd., Kyoto (JP)

(72) Inventors: Hiroaki TAKAHASHI, Kyoto (JP); Koji HIRATA, Kyoto (JP); Koji FUJITA, Kyoto (JP)

(73) Assignee: Maxell, Ltd., Kyoto (JP)

(21) Appl. No.: 19/099,497

(22) PCT Filed: Mar. 28, 2023
(86) PCT No.: PCT/JP2023/012608

§ 371 Date: Jan. 29, 2025

(30) Foreign Application Priority Data
Aug. 23, 2022 (JP) 2022-132214

(51) Int. Cl. G02B 30/56

(52) U.S. Cl. CPC G02B 30/56

(57) ABSTRACT

An air floating video display apparatus configured to display an air floating video, including a housing configured to store a video display apparatus, a retroreflector arranged outside the housing so as to face the video display apparatus and having a λ/4 plate provided on a retroreflection surface, and a polarization separation member arranged in a space connecting the video display apparatus and the retroreflector outside the housing, the video display apparatus including a light source apparatus and a liquid crystal display panel as a video source, and a video light of a specific polarized wave entering the polarization separation member, passing through the polarization separation member, being reflected by the retroreflector, and passing through the λ/4 plate, the video light of the other polarized wave being reflected by the polarization separation member, and the air floating video being displayed.

### TECHNICAL FIELD

This disclosure relates to a technique for an air floating video display apparatus.

### BACKGROUND ART

As an example of the air floating video display apparatus, Japanese Unexamined Patent Application Publication No. 2019-128722 (Patent Document 1) is cited. Patent Document 1 includes the description of “a CPU of an information processing apparatus includes an approaching direction detector configured to detect an approaching direction of a user to an image formed in the air, an input coordinate detector configured to detect coordinates where an input is detected, an operation receiver configured to process a reception of operation, and an operation screen updater configured to update an operation screen according to a received operation. The CPU receives a motion of the user as an operation when the user approaches the image from a predetermined direction, and performs the processing according to the operation”.

### RELATED ART DOCUMENTS

### Patent Documents

Patent Document 1: Japanese Unexamined Patent Application Publication No. 2019-128722

### SUMMARY OF THE INVENTION

### Problems to be Solved by the Invention

Although the air floating video display apparatus of Patent Document 1 can improve the operability of the air floating video, it does not take into consideration the improvement of the visual resolution and contrast of the air floating video. Thus, further improvement in video quality of the air floating video has been demanded under current circumstances.

The air floating video display apparatuses have a wide range of applications, and can achieve the effect of attracting the attention of a lot of people from the rarity of “displaying video floating in the air” that is not possible in the conventional flat display if used as signage (advertising billboards). In addition, as described in Patent Document 1, if an air floating video is used as a human interface for performing some kind of operation, it is possible to achieve the effect of preventing virus infection via contact parts such as push buttons owing to its non-contact feature. Further, if the air floating video display apparatus can be easily installed in a study or living room at home or a workplace, letters, figures, moving images, etc. that are conventionally displayed simply on a liquid crystal screen or the like would be displayed as air floating videos, which would be visually enjoyable and would also be favorable as an interior accessory.

On the other hand, when the air floating video display apparatus is used indoors, in particular, in a living room where the family gathers or in an office room of a workplace where at least several people are present, it is desirable that only the specific individual using it (hereinafter, referred to as user) can see the air floating video. However, as will be described later, there is a problem in that a video light emitted from the video source that is the origin of the air floating video is visually recognized by a person located on the opposite side of the position of the user's eyes. It has been desired to solve this problem, that is, to make the video light invisible to the person who is located on the opposite side of the user's eyes other than the user.

An object of this disclosure is to provide a technique related to an air floating video display apparatus capable of making the video light invisible to the person who is located on the opposite side of the user's eyes when the user visually recognizes the air floating video. Also, an object of this disclosure is to provide a technique capable of displaying an air floating video suitable for indoor use and having high visibility.

### Means for Solving the Problem

In order to solve the problem described above, for example, the configuration described in claims is adopted. This application includes a plurality of means for solving the problem above, and one example thereof can be presented as follows. That is, an air floating video display apparatus according to an embodiment is an air floating video display apparatus configured to display an air floating video, and includes: a retroreflector arranged so as to face a video display apparatus and having a 1/4 plate (retardation plate, quarter-wave plate) provided on a retroreflection surface; and a polarization separation member arranged at a predetermined angle with respect to the video display apparatus and the retroreflector, in a space connecting the video display apparatus and the retroreflector, the video display apparatus includes a light source apparatus and a liquid crystal display panel as a video source, and a video light of a specific polarized wave emitted from the liquid crystal display panel, specifically, P-polarized video light passes through the polarization separation member (referred to also as beam splitter), is reflected by the retroreflector, and passes through the λ/4 plate twice to be subjected to polarization conversion into a video light of S-polarization. As a result, the S-polarized video light reflected by the retroreflector is reflected by the polarization separation member, and the air floating video that is a real image is displayed at a predetermined position based on the reflected video light.

Here, when the P-polarized video light passes through the beam splitter, a part of the P-polarized video light is reflected without passing through the beam splitter. At this time, a problem arises in that the part of the reflected video light reflected by the beam splitter can be visually recognized by a person located on the back side of the air floating video display apparatus, more specifically, on the opposite side of the position of the eyes of the user who visually recognizes the air floating video.

The air floating video display apparatus of the present embodiment is configured such that the reflected video light reflected by the beam splitter is not generated or the amount of the reflected video light is sufficiently reduced. More specifically, the air floating video display apparatus of the present embodiment is configured such that the reflected video light is not generated by setting the incident angle of the video light (P-polarized video light) on the beam splitter at a predetermined angle (Brewster's angle: θB).

### Effects of the Invention

According to a typical embodiment of this disclosure, when a user visually recognizes an air floating video using an air floating video display apparatus, it is possible to make a video light invisible to a person located on the opposite side of the Also, according to a typical position of the user's eyes. embodiment, it is possible to display an air floating video suitable for indoor use and having high visibility. Further, according to a typical embodiment, an air floating video display apparatus is configured such that a bright air floating video having high visibility can be displayed and a reflected video light, which is generated by reflecting a video light to be an origin to form the air floating video by a beam splitter, is not generated or the light amount of the reflected video light can be sufficiently reduced. In this way, it is possible to provide an air floating video display apparatus capable of achieving the effect of making the reflected video light invisible to a person located on the opposite side of the position of the user's eyes. The above-mentioned problems and other problems, configurations for solving these problems, effects, and others will become apparent from the following description of the embodiments.

### BRIEF DESCRIPTION OF THE DRAWINGS

FIG. 1 is a diagram illustrating an example of a usage mode of an air floating video display apparatus according to an implementation example.

FIG. 2 is a diagram illustrating a V-shape configuration as an example of a main part configuration of the air floating video display apparatus according to the implementation example.

FIG. 3 is a diagram illustrating a Z-shape configuration as an example of the main part configuration of the air floating video display apparatus according to the implementation example.

FIG. 4 is a diagram illustrating an example of a detailed structure of a retroreflector.

FIG. 5 is a characteristic diagram illustrating a relationship between a surface roughness of the retroreflector and a blur amount of a retroreflection image (air floating video).

FIG. 6 is a diagram illustrating a configuration example of a video display apparatus according to the implementation example.

FIG. 7 is a diagram illustrating an external configuration example of an air floating video display apparatus according to an implementation example (first implementation example).

FIG. 8 is a cross-sectional view illustrating a configuration example of the air floating video display apparatus according to the implementation example (first implementation example) viewed from the side.

FIG. 9 is a perspective view illustrating an external configuration example of an air floating video display apparatus according to an implementation example (second implementation example).

FIG. 10 is a cross-sectional view illustrating a configuration example of the air floating video display apparatus according to the implementation example (second implementation example) viewed from the side.

FIG. 11 is a diagram illustrating a relationship between an incident angle and a reflectance and Brewster's angle.

FIG. 12 is a perspective view illustrating an external configuration example of an air floating video display apparatus according to an implementation example (third implementation example).

FIG. 13 is a cross-sectional view illustrating a configuration example of the air floating video display apparatus according to the implementation example (third implementation example) viewed from the side.

FIG. 14 is a diagram illustrating a mounting example of a λ/2 plate in a video display section in an air floating video display apparatus according to an implementation example (modification of the second implementation example).

### DETAILED DESCRIPTION OF PREFERRED EMBODIMENTS

Hereinafter, an embodiment of this disclosure will be described in detail with reference to the drawings. In the drawings, the same components are denoted by the same reference characters in principle, and repeated description thereof will be omitted. In the drawings, for easy understanding of the invention, each component does not represent an actual position, size, shape, range, and the like in some cases. In terms of description, in a case where processing by a program is described, the program, a function, a processor, and the like are mainly described in some cases, but the main body thereof as hardware is a processor or a controller, an apparatus, a computer, a system, or the like composed of the processor or the like. The computer executes processing in accordance with a program read on a memory by the processor, while appropriately using resources such as a memory or a communication interface. As a result, a predetermined function, a processing unit, and the like are implemented. The processor is composed of, for example, a semiconductor device such as a CPU/MPU or a GPU, or the like. The processor is composed of a device and a circuit that can perform predetermined calculation. The processing is not limited to software program processing and can be implemented by a dedicated circuit. As the dedicated circuit, an FPGA, an ASIC, a CPLD, or the like can be applied. The program may be installed in a target computer in advance as data or may be distributed and installed as data from a program source to the target computer. The program source may be a program distribution server on a communication network or may be a non-transitory computer-readable storage medium such as a memory card, disk, or the like. The program may be composed of a plurality of modules. A computer system may be composed of a plurality of apparatuses. The computer system may be composed of a client server system, a cloud computing system, or the like. Various types of data and information are composed of, for example, a structure of a table, a list, or the like, but are not limited thereto. Expressions such as identification information, an identifier, an ID, a name, and a number can be replaced with each other.

### Embodiment

An air floating video display apparatus according to an embodiment includes a video display apparatus, a beam splitter that is a polarization separation member, and a retroreflector in which a λ/4 plate (retardation plate, quarter-wave plate) is provided on a retroreflection surface. The video display apparatus includes a light source apparatus and a display panel or a liquid crystal display panel configured to emit a video light of a specific polarized wave (for example, P-polarized light) as a video source (video display element). The light source apparatus generates and supplies light as backlight to the liquid crystal display panel. The polarization separation member is disposed in a space connecting the liquid crystal display panel of the video display apparatus and the retroreflector. The polarization separation member has a property of transmitting the video light of the specific polarized wave from the liquid crystal display panel toward the retroreflector and reflecting the video light of the other polarized wave (for example, S-polarized light) that has been subjected to polarization conversion by the retroreflector and the λ/4 plate. The video light of the other polarized wave after the reflection generates and displays an air floating video that is a real image at a predetermined position in a direction different from the video display apparatus.

In order to improve a contrast performance of the air floating video, the video display apparatus may be provided with a polarization converter configured to align light source light from the light source apparatus with polarized light in a specific direction. For example, the light source apparatus includes a point-like or planar light source, an optical element that reduces a divergence angle of light from the light source, the polarization converter (polarization conversion element or the like) that aligns the light from the light source with polarized light in a specific direction, and a light guide body having a reflection surface that propagates the light from the light source to the liquid crystal display panel, and the light source apparatus controls a video light flux of the video light from the liquid crystal display panel based on a shape and a surface roughness of the reflection surface of the light guide body.

Although not limited, in consideration of the indoor use in particular, the air floating video display apparatus according to the embodiment includes a video display section having a housing that can be installed on a desk and an air floating video display having a frame structure.

The video display section mainly includes a liquid crystal display panel and a light source (backlight).

The air floating video display is configured to include an optical system made up of a polarization separation member and a retroreflector. The optical system of the embodiment has a structure supported by a frame made of metal or resin.

### Air Floating Video Display Apparatus

The following implementation example relates to, for example, an air floating video display apparatus capable of transmitting a video by video light from a large-area video light emitting source via a transparent member that partitions a space such as a glass of a show window and displaying the video as an air floating video inside or outside a space of a store. Furthermore, apart from the implementation example above, the following other implementation examples relate to an air floating video display apparatus capable of displaying a video by video light from a small-area (for example, about two to five inches) video light emitting source as an air floating video mainly indoors, by using an optical system composed of a polarization separation member (in other words, polarization beam splitter or simply beam splitter), a retroreflection plate, and the like to be described later.

Note that, in the description of the implementation examples below, a video floating in a space is expressed as a term “air floating video”. Instead of this term, expressions such as an “aerial image”, an “aerial floating video”, an “air floating optical image of a display image”, or an “aerial floating optical image of a display image” may be used. The term “air floating video” used in the description of the implementation examples is used as a representative example of these terms.

According to the following implementation examples, for example, high-resolution video information can be displayed on a glass surface of a show window or a light transmissive plate material in an air floating state. Furthermore, the air floating video display apparatus according to the implementation examples can be installed even in a relatively small space, for example, on a desk in a study, on a table in a living room, on a counter kitchen, or the like. Further, according to the implementation examples, it is possible to provide an air floating video display apparatus capable of making the reflected video light (details are described below) invisible to a person located on the opposite side of a user who can visually recognize the air floating video across the air floating video display apparatus. According to the implementation examples, it is possible to provide an air floating video display apparatus favorably used indoors as an interior accessory or a display apparatus for an information equipment.

In the conventional air floating video display apparatus according to the related art, an organic EL panel or a liquid crystal display panel as a high-resolution color display video source is used in combination with a retroreflector. In the conventional air floating video display apparatus according to the related art, since video light is diffused at a wide angle, there have been following problems.

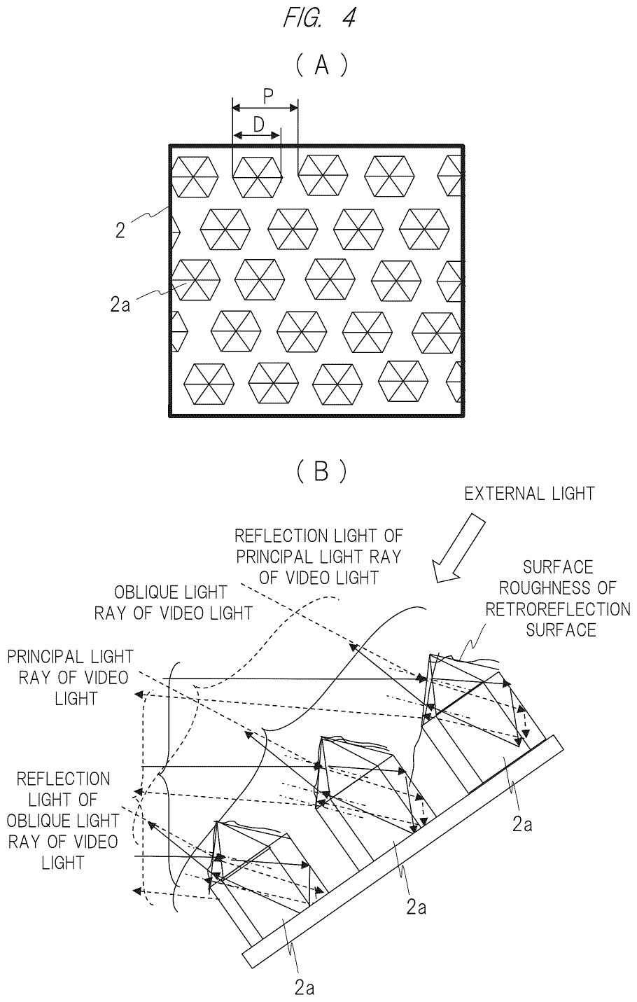

As illustrated in FIG. 4, since a retroreflection portion 2a is a hexahedron in a retroreflector 2, a ghost image is generated by the video light obliquely entering the retroreflector 2 in addition to the reflection light reflected normally, and this causes the problem of deteriorating the image quality of the air floating video. The retroreflector 2 is referred to also as a retroreflection plate or a retroreflection sheet.

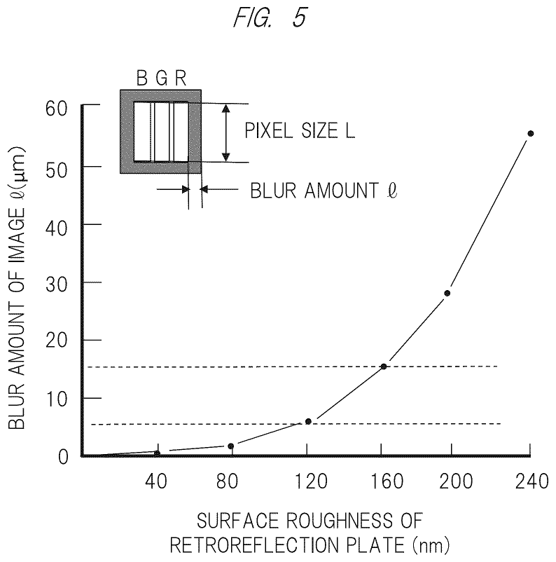

Furthermore, as illustrated in FIG. 5, in an air floating video obtained by reflecting the video light from the video display apparatus as the video source by the retroreflector 2, there is also the problem of generating a blur for each pixel of the liquid crystal display panel in addition to the ghost image described above.

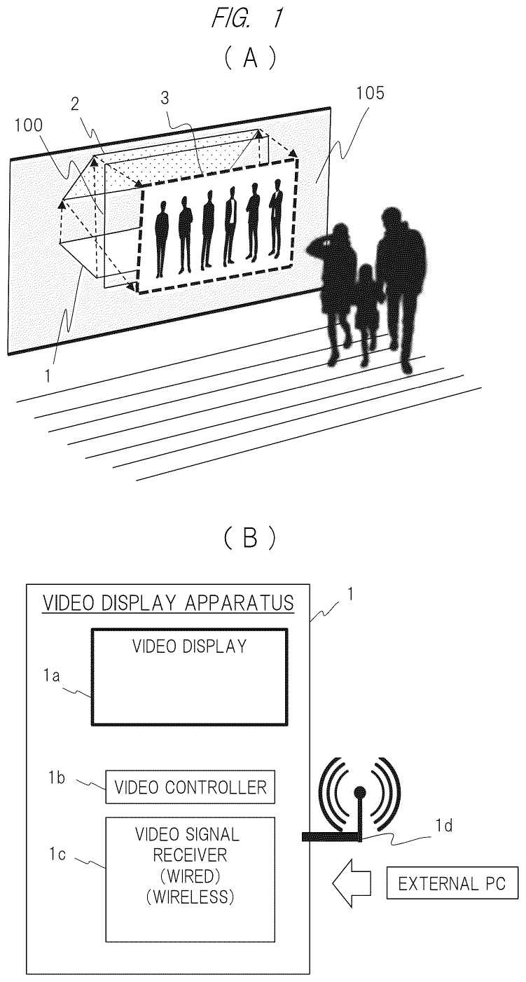

FIG. 1 illustrates an example of usage mode and a configuration example of an air floating video display apparatus according to one implementation example. FIG. 1(A) illustrates an overall configuration of the air floating video display apparatus according to this implementation example. For example, in a store or the like, a space is partitioned by a show window (window glass) 105 which is a light transmissive member such as a glass (described also as transparent member). The air floating video display apparatus according to this implementation example can display the air floating video to the outside of the space of the store in a single direction through such a transparent member. Specifically, light of a specific polarized wave with narrow-angle directional characteristics is emitted as a video light flux from a video display apparatus 1 in the air floating video display apparatus, once enters the retroreflector 2, is retroreflected and passes through the window glass 105, thereby forming an air floating video 3 that is a real image on the outside of the space of the store. FIG. 1(A) illustrates the case where the far side of the window glass 105 in the depth direction is the space inside the store and the near side in the depth direction is the space outside the store (for example, sidewalk). On the other hand, the air floating video 3 can be formed at a desired position in the store by providing a reflector (optical member or the like) configured to reflect a specific polarized wave on the window glass 105 and reflecting the video light flux.

FIG. 1(B) illustrates a block configuration of the video display apparatus 1 described above. The video display apparatus 1 includes a video display 1a configured to display an original image of the air floating video 3, a video controller 1b configured to convert an input video in accordance with the resolution of a panel of the video display 1a, a video signal receiver 1c configured to receive a video signal, and a receiving antenna 1d. The video signal receiver 1c is configured to handle signals input via a wired communication such as a universal serial bus (USB: registered trademark) input or a high-definition multimedia interface (HDMI: registered trademark) input and handle signals input via a wireless communication such as wireless fidelity (Wi-Fi: registered trademark). The video display apparatus 1 can function independently as a video receiver/display, and can also display video information from an external PC, a tablet, a smartphone, and the like. Further, if a stick PC or the like is connected, the video display apparatus 1 can have the capability of calculation processing, image analysis processing, and the like.

### Air Floating Video Display Apparatus (V Shape)

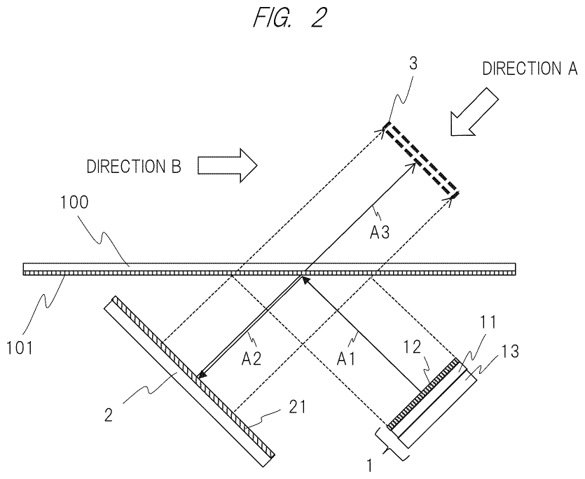

FIG. 2 illustrates a configuration example of a main part of the air floating video display apparatus according to the implementation example. The implementation example in FIG. 2 illustrates a configuration in which the video display apparatus 1 and the retroreflector (in other words, retroreflection plate) 2 are arranged in an approximately V shape (hereinafter, referred to as V-shape configuration). As illustrated in FIG. 2, in the V-shape configuration, the video display apparatus 1 configured to generate the video light of the specific polarized wave is provided in an oblique direction (direction corresponding to optical axis A1) with respect to a transparent member 100 such as flat glass (arranged in horizontal direction in this example). Furthermore, the retroreflector 2 is provided in another oblique direction (direction corresponding to optical axis A2) with respect to the transparent member 100 such as flat glass. The video display apparatus 1 includes a light source apparatus 13, a liquid crystal display panel 11 that is a liquid crystal display element, an absorption-type polarization plate 12, and the like.

In FIG. 2, the video light of the specific polarized wave emitted from the liquid crystal display panel 11 of the video display apparatus 1 travels in the direction of the optical axis A1 to be reflected by a beam splitter 101 (polarization separation member) that is provided on the transparent member 100 and has a film for selectively reflecting the video light of the specific polarized wave, and the reflected light travels in the direction of the optical axis A2 to enter the retroreflector 2. In this example, the beam splitter 101 is formed in a sheet-like shape and is adhered to a lower surface of the transparent member 100 such as flat glass. Alternatively, the beam splitter 101 may be formed by directly depositing an optical thin film on flat glass.

A λ/4 plate 21 is provided on a video light incident surface (in other words, retroreflection surface) of the retroreflector 2. In other words, the λ/4 plate 21 is a polarization conversion element, a retardation plate, or a quarter-wave plate.

The video light on the optical axis A2 from the beam splitter 101 is subjected to polarization conversion from the specific polarized wave (one polarization) to the other polarized wave, by passing through the λ/4 plate 21 twice in total at the time of entering the retroreflector 2 and at the time of emission from the retroreflector 2. Here, the beam splitter 101 configured to selectively reflect the video light of the specific polarized wave has a property of transmitting the video light of the other polarized wave after the polarization conversion. Therefore, the video light of the other polarized wave after the polarization conversion passes through the beam splitter 101. The video light that has passed through the beam splitter 101 forms and displays the air floating video 3 that is a real image, at a predetermined position outside the transparent member 100 in a direction of an optical axis A3 corresponding to the optical axis A2.

Note that the light that forms the air floating video 3 is a set of light rays converging from the retroreflector 2 to the optical image of the air floating video 3, and these light rays go straight even after passing through the optical image of the air floating video 3. Therefore, in the configuration of FIG. 2, when the user visually recognizes the air floating video 3 from the direction A indicated by an arrow corresponding to the optical axis A3, the air floating video 3 is visually recognized as a bright video. However, when another person visually recognizes the video from, for example, the direction B indicated by an arrow, the air floating video 3 cannot be visually recognized as a video at all. Such characteristics are very suitable in a case of being adopted in a system that displays a video requiring high security or a highly confidential video that is desired to be kept secret from a person facing the user.

Note that, depending on the performance of the retroreflector 2, the polarization axes of the video light after reflection become uneven in some cases. In this case, a part of the video light whose polarization axes become uneven is reflected by the beam splitter 101 described above and returns to the video display apparatus 1. This returned light is reflected again on the video display surface of the liquid crystal display panel 11 constituting the video display apparatus 1, so that the ghost image is generated and the image quality of the air floating video 3 is deteriorated in some cases. Therefore, in this implementation example, an absorption-type polarization plate 12 is provided on the video display surface of the video display apparatus 1. The video light emitted from the video display apparatus 1 is transmitted through the absorption-type polarization plate 12, and the reflected light returning from the beam splitter 101 is absorbed by the absorption-type polarization plate 12. In this way, the re-reflection described above can be suppressed,, and it is possible to prevent deterioration in image quality of the air floating video 3 due to the ghost image.

The beam splitter (polarization separation member) 101 described above may be formed of, for example, a reflection-type polarization plate or a metal multilayer film that reflects a specific polarized wave. More specifically, the beam splitter 101 can be formed by depositing an optical thin film on flat glass (for example, quartz glass).

### Air Floating Video Display Apparatus (Z Shape)

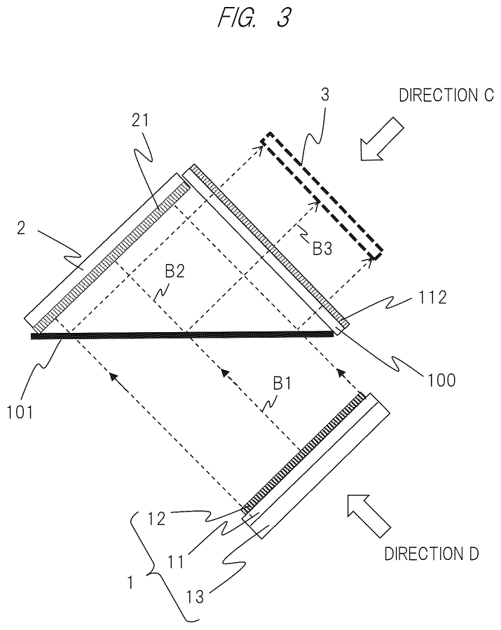

FIG. 3 illustrates a configuration example of the main part of the air floating video display apparatus according to an implementation example different from the implementation example in FIG. 2. The implementation example in FIG. 3 illustrates a configuration in which the video display apparatus 1 and the retroreflector 2 (retroreflection plate) are arranged to face each other, and the beam splitter 101 is arranged in the space therebetween at an angle of about 45 degrees with respect to each of the video display apparatus 1 and the retroreflector 2 so as to form a schematically Z shape (or reverse Z shape) (hereinafter, referred to as Z-shape configuration).

In the Z-shape configuration illustrated in FIG. 3, the transparent member 100 such as a glass plate and an absorption-type polarization plate 112 are provided for the purpose of reducing the influence on the retroreflector 2 and the video display apparatus 1 due to external light entering in a direction C. As illustrated in FIG. 3, the video display apparatus 1 and the retroreflector 2 are arranged at an angle of about 90 degrees with respect to the transparent member 100 and the absorption-type polarization plate 112, and are arranged at an angle of about 45 degrees with respect to the beam splitter 101. In this implementation example, the beam splitter 101 is arranged in the horizontal direction, and the position of the video display apparatus 1, more specifically, the position of the video displayed on the liquid crystal display panel 11 and the position where the air floating video 3 is formed are in a plane-symmetrical relationship with respect to the beam splitter 101.

### Retroreflector

FIG. 4(A) illustrates a surface shape of the retroreflector 2 (retroreflection plate) manufactured by Nippon Carbide Industries Co., Inc. used in this study as the typical retroreflector 2. FIG. 4(A) is a top view and FIG. 4(B) is a On the surface of the retroreflector 2, the side view. retroreflection portions 2a composed of regularly arranged hexagonal columns are provided. The light ray that has entered the retroreflection portion 2a is reflected by the wall surfaces and bottom surface of the hexagonal column and emitted as retroreflected light in a direction corresponding to the incident light. This emitted light forms the air floating video 3 as a normally reflected image (normal image) in the configurations illustrated in FIG. 2 and FIG. 3. On the other hand, as illustrated in FIG. 4(B), the ghost image (not illustrated) is formed at the position different from the normal image by the video light, which has obliquely entered the retroreflector 2, of the video light from the video display apparatus 1. This ghost image lowers the visibility of the air floating video 3.

Thus, in this implementation example (FIG. 3), the air floating video 3 that is a real image is displayed based on the video displayed on the video display apparatus 1 without forming the ghost image. The resolution of the air floating video 3 largely depends on the outer diameter D and pitch P of the retroreflection portions 2a of the retroreflector 2 illustrated in FIG. 4(A), in addition to the resolution of the liquid crystal display panel 11. For example, when the liquid crystal display panel 11 of a 7-inch WUXGA (1920×1200 pixels) is used, even if one pixel (one triplet) is about 80 μm, one pixel of the air floating video 3 is about 300 μm if the diameter D of the retroreflection portion 2a is 240 μm and the pitch P is 300 μm, for example. Therefore, the effective resolution of the air floating video 3 is reduced to about ⅓. Therefore, in order to make the resolution of the air floating video 3 equal to the resolution of the video display apparatus 1, it is desired that the diameter D and the pitch P of the retroreflection portions 2a are close to one pixel of the liquid crystal display panel. On the other hand, in order to suppress the occurrence of moire caused by the retroreflector 2 and the pixels of the liquid crystal display panel 11, it is preferable to design each pitch ratio so as not to be an integral multiple of one pixel. Further, the shape is preferably arranged such that any one side of the retroreflection portion 2a does not overlap with any one side of one pixel of the liquid crystal display panel 11.

The inventors of this application fabricated the video display apparatus 1 by combining the liquid crystal display panel 11 with a pixel pitch of 40 um and the light source apparatus 13 with a narrow divergence angle (divergence angle of) 15° of this implementation example, and obtained the relationship between the acceptable blur amount 1 (small L) of the image of the air floating video 3 and the pixel size L (large L) by experiment in order to improve the visibility. FIG. 5 illustrates the experimental results. It has been found that the blur amount 1 that deteriorates the visibility is preferably 40% or less of the pixel size, and the blur is almost unnoticeable if it is 15% or less. Also, it has been found that the surface roughness of the reflection surface by which the blur amount 1 is an acceptable amount in this case has an average roughness of 160 nm or less in the range of the measurement distance of 40 μm, and the surface roughness of the reflection surface is desirably 120 nm or less for achieving the more unnoticeable blur amount 1. Therefore, it is desirable to reduce the surface roughness of the retroreflector 2 described above and reduce the surface roughness including the reflection film forming the reflection surface and its protection film to the above-described value or less.

On the other hand, in order manufacture the retroreflector 2 at a low cost, the retroreflector may be molded by using the roll press method. Specifically, this is a method of aligning retroreflection portions 2a and forming the retroreflection portions 2a on a film. In this method, the retroreflector 2 having a desired shape is obtained by forming a reverse shape of the shape to be formed on a roll surface, applying an ultraviolet curable resin on a fixing base material, forming a necessary shape by passing the resin between rolls, and curing the resin by irradiation with ultraviolet rays.

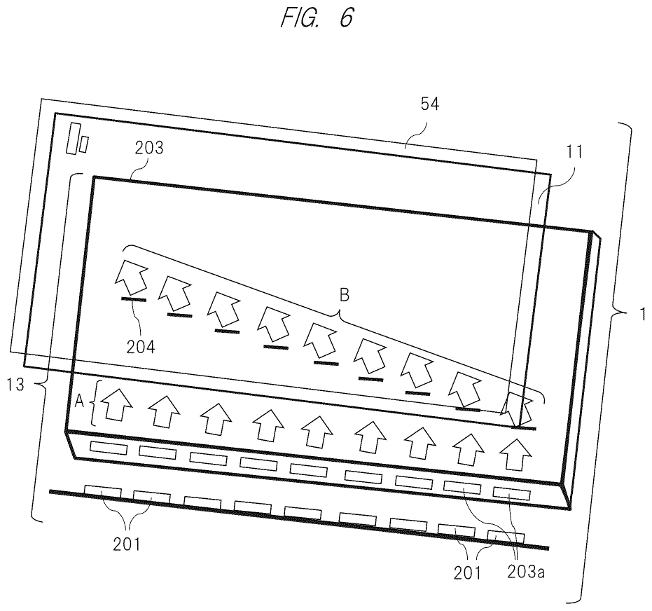

The video display apparatus 1 of this implementation example includes the liquid crystal panel 11 and the light source apparatus 13 (details in FIG. 6) configured as a light source to generate a light of a specific polarized wave, and thus there is low probability that the video light enters obliquely with respect to the retroreflector 2 described above. As a result, it is possible to provide the structurally superior system in which the generation of the ghost image can be suppressed and the brightness of the ghost image is low even if the ghost image is generated.

On the other hand, in the configuration of the Z-shape air floating video display apparatus illustrated in FIG. 3, the video display apparatus 1 including the liquid crystal display panel 11, the absorption-type polarization plate 12, and the light source apparatus 13 is arranged at a predetermined angle (for example, at an angle of about 45 degrees with respect to the beam splitter 101 on horizontal plane). The video light from the video display apparatus 1 passes through the beam splitter 101 in a direction of an optical axis B1 (oblique direction with respect to the beam splitter 101) and travels toward the retroreflector 2 in a direction of an optical axis B2 (corresponding to direction D) corresponding to the optical axis B1.

Here, the video light from the video display apparatus 1 is, for example, a video light having characteristics of P polarization (Parallel Polarization) as the light of the specific polarized wave. Furthermore, the beam splitter 101 is a polarization separation member such as a reflection-type polarization plate and has a property of transmitting the video light of P polarization from the video display apparatus 1 and reflecting the video light of S polarization (Senkrecht Polarization). This beam splitter 101 is formed of a reflection-type polarization plate or a metal multilayer film that reflects the specific polarized wave. This beam splitter 101 can be formed by depositing an optical thin film on a flat glass substrate in general. Therefore, a refractive index of the beam splitter 101 has substantially the same value as a refractive index n of flat glass (n=about 1.5).

On the other hand, the λ/4 plate 21 is provided on the light incident surface (retroreflection surface) of the retroreflector 2. The video light of P polarization that has passed through the beam splitter 101 from the video display apparatus 1 is subjected to polarization conversion from the P polarization to the S polarization, by passing through the 2/4 plate 21 twice in total at the time of entering the retroreflector 2 and at the time of emission from the retroreflector 2. As a result, the video light of S polarization from the retroreflector 2 after the polarization conversion is reflected by the beam splitter 101 and travels toward the transparent member 100 or the like. The reflected video light of S polarization that has traveled in a direction corresponding to an optical axis B3 (oblique direction with respect to the beam splitter 101) passes through the transparent member 100 such as a glass plate and the absorption-type polarization plate 112, and generates and displays the air floating video 3 that is a real image at a predetermined position outside the transparent member 100 or the like.

Here, in order to suppress the deterioration in the image quality due to sunlight and illumination light entering the optical system composed of optical components such as the video display apparatus 1, the retroreflector 2, and the beam splitter 101, it is effective to provide the absorption-type polarization plate 112 on an outer surface of the transparent member 100. Since the polarization axes become uneven in some cases when the light is retroreflected by the retroreflector 2, a part of the video light is reflected by the beam splitter 101 and is returned toward the video display apparatus 1 in some cases. This returned light is reflected again by the video display surface of the liquid crystal display panel 11 constituting the video display apparatus 1, so that the ghost image is generated and the image quality of the air floating video 3 is significantly deteriorated.

Therefore, in both of the implementation examples illustrated in FIG. 2 and FIG. 3, the absorption-type polarization plate 12 is provided on the video display surface of the video display apparatus 1. Alternatively, an antireflection film (not illustrated) may be provided on a video emission side surface of the absorption-type polarization plate 12 provided on the surface of the video display apparatus 1. In this way, the light to be the cause of generating the ghost image is absorbed by the absorption-type polarization plate 12, whereby the deterioration in the image quality due to the ghost image of the air floating video 3 is prevented.

Moreover, in the Z-shape configuration in FIG. 3, a strong ghost image is generated when external light directly enters the retroreflector 2. Therefore, in order to suppress and prevent the generation of the ghost image, this implementation example has the configuration in which the retroreflector 2 is inclined downward with respect to an incident direction of the external light for preventing the entry of the external light. Specifically, a main incident direction of the external light is set to a direction (oblique direction like the optical axis B3) corresponding to a direction C indicated by an arrow (direction in which user visually recognizes the air floating video 3 from front side). In that case, the retroreflector 2 is arranged such that the optical axis B2 has a relationship of, for example, about 90 degrees with respect to the direction C (optical axis B3). In other words, a main surface of the retroreflector 2 is arranged so as to have a relationship of, for example, about 90 degrees with respect to a main surface of the transparent member 100 or the like. In this way, since the external light entering in the direction C does not directly enter the main surface (retroreflection surface) of the retroreflector 2, the generation of the ghost image is prevented.

Furthermore, the video display apparatus 1 is arranged in a direction different from the incident direction (direction C) of the external light. Specifically, the main surface (video light emission surface) of the video display apparatus 1 is arranged in the same direction as (in other words, in parallel to) the main surface of the retroreflector 2, and the optical axis B1 of the video display apparatus 1 is arranged to have a relationship of about 90 degrees with respect to the optical axis B3 corresponding to the incident direction (direction C) of the external light. Furthermore, when a range of a light flux in a case where the external light enters the main surface of the transparent member 100, which functions as an opening, in the direction C is considered, the video display apparatus 1 is arranged at a position slightly separated outside from the range.

As a result, the generation of the ghost image due to the re-reflection in the video display apparatus 1 is reduced.

### Video Display Apparatus

FIG. 6 illustrates a configuration example of the video display apparatus 1 that is applicable to the implementation examples in FIG. 2 and FIG. 3. The video display apparatus 1 includes the light source apparatus 13, the liquid crystal display panel 11, a light direction conversion panel 54, and the like. On a video emission surface side of the liquid crystal display panel 11, the absorption-type polarization plate 12 described above may be provided. The light source apparatus 13 is composed of a plurality of light emitting diode (LED) elements 201 that is a semiconductor light source (solid light source) constituting a light source, a light guide body 203, and the like. In FIG. 6, a state where the liquid crystal display panel 11 and the light direction conversion panel 54 are arranged on a light emission side of the light source apparatus 13 is illustrated as an exploded perspective view.

The light source apparatus 13 is formed of, for example, a case (not illustrated) made of plastic or the like and is configured to store the LED elements 201 and the light guide body 203 therein. A light receiving end surface 203a is provided on a light incident side of the light guide body 203 in order to convert divergent light from each LED element 201 into a substantially parallel light flux. The light receiving end surface 203a has a shape whose cross sectional area gradually increases toward a facing surface with respect to the light receiving portion, and is provided with a lens shape having a function of gradually decreasing a divergence angle by making total reflection plural times during propagation therein.

Moreover, on an upper surface of the light guide body 203, the liquid crystal display panel 11 that is arranged substantially parallel to the light guide body 203 is attached. The upper surface of the light guide body 203 refers to an emission surface from which the light reflected by the light guide body 203 is emitted. Furthermore, on one side surface (side surface on the lower side in FIG. 6) of the case of the light source apparatus 13, the plurality of LED elements 201 is attached. The light from the plurality of LED elements 201 is converted into substantially collimated light (substantially parallel light) by the shape of the light receiving end surface 203a of the light guide body 203. Therefore, the light receiving portion of the light receiving end surface 203a and the LED element 201 are attached so as to maintain a predetermined positional relationship.

The light source apparatus 13 is configured by attaching a light source unit, in which the plurality of LED elements 201 serving as a light source is arranged, to the light receiving end surface 203a serving as the light receiving portion provided on the light incident side of the light guide body 203. A divergent light flux from the LED element 201 is converted into the substantially collimated light by a lens shape of the light receiving end surface 203a of the light guide body 203. The substantially collimated light is guided in the direction A indicated by the arrow inside the light guide body 203. The direction A is a direction substantially parallel to the liquid crystal display panel 11 (direction from bottom to top in drawing). A light flux direction of the light guided in the direction A is converted by a light flux direction converter 204 provided in the light guide body 203, and the light is emitted in a direction B indicated by an arrow toward the liquid crystal display panel 11 substantially parallel to the light guide body 203. The direction B is a direction substantially perpendicular to a display surface of the liquid crystal display panel 11.

The light guide body 203 has a configuration in which a distribution (in other words, density) of the light flux direction converter 204 is optimized by the shape of the inside or the surface of the light guide body 203. Accordingly, it is possible to control uniformity of light that is an emission light flux from the light source apparatus 13 indicated by the direction B and is an incident light flux to the liquid crystal display panel 11.

Moreover, in the video display apparatus 1 configured to include the light source apparatus 13 and the liquid crystal display panel 11, it is also possible to control directivity of the light from the light source apparatus 13 in the direction B in order to improve utilization efficiency of the emission light flux from the light source apparatus 13 indicated by the direction B and largely reduce power consumption. More specifically, a light source that has a narrow divergence angle can be configured as the light source apparatus 13. As a result, the video light from the video display apparatus 1 efficiently reaches an observer with high directivity (in other words, straightness) like laser light, and it is possible to display a high-quality air floating video with high resolution. At the same time, power consumption by the video display apparatus 1 including the LED elements 201 of the light source apparatus 13 can be significantly reduced.

Also, to a frame (not illustrated) of the liquid crystal display panel 11 attached to the upper surface of the case (not illustrated) of the light source apparatus 13, the liquid crystal display panel 11 attached to the frame, a flexible printed circuits (FPC) board (not illustrated) electrically connected to the liquid crystal display panel 11, and the like are attached. The liquid crystal display panel 11 which is a liquid crystal display element generates a display video together with the LED element 201 by modulating the intensity of transmitted light based on a control signal from a control circuit (not illustrated) constituting an electronic device.

### Desktop-type Air Floating Video Display Apparatus (Z Shape)

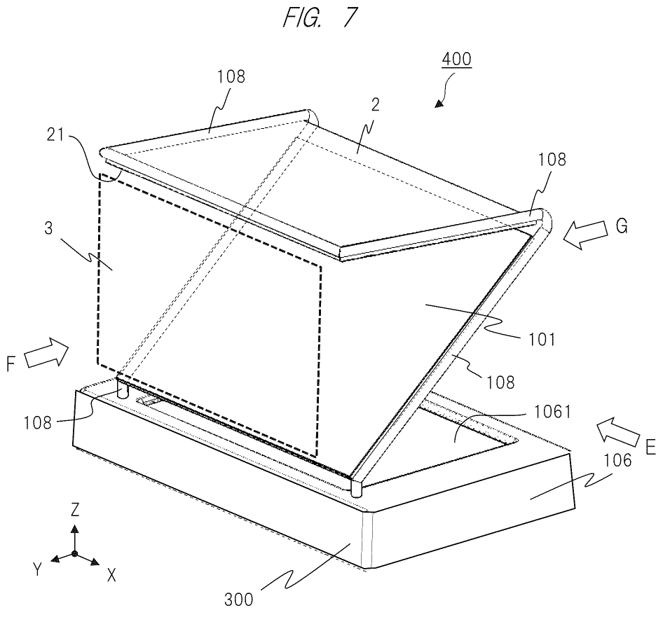

Next, a desktop-type air floating video display apparatus according to each implementation example will be described with reference to FIG. 7 and subsequent drawings. The air floating video display apparatus according to each implementation example below corresponds to the Z-shape configuration illustrated in FIG. 3 as a basic configuration. For the function to form the air floating video 3, the components (video display apparatus 1, beam splitter 101, retroreflector 2, and the like) of the air floating video display apparatus are fixed to each other so as to have a predetermined positional relationship.

### First Implementation Example

FIG. 7 illustrates an external configuration example of the air floating video display apparatus suitable for desktop use according to an implementation example (referred to as first implementation example). The air floating video display apparatus according to the first implementation example illustrated in FIG. 7 roughly includes a video display section 300 (corresponding housing 106) and an air floating video display 400. The video display section 300 is mounted and stored in the housing 106 (in other words, container of the video display apparatus 1). The air floating video display 400 is composed of the retroreflector 2, the λ/4 plate 21, the beam splitter 101, the frame 108 that supports them, and others.

In FIG. 7, when the illustrated X-Y plane is taken as a desk surface (horizontal plane in this example), the housing 106 is placed on the desk surface. The housing 106 schematically has a plate-like rectangular shape with a predetermined height. The video display apparatus 1 is arranged inside the housing 106 along the desk surface. The air floating video display 400 is arranged on the housing 106. The beam splitter 101 is arranged obliquely with respect to the desk surface. Above the beam splitter 101, the retroreflector 2 and the λ/4 plate 21 are arranged along the desk surface. The λ/4 plate 21 is arranged so as to face downward with respect to the retroreflector 2 located above. In other words, the λ/4 plate 21 is arranged on the light incident side of the retroreflector 2. The air floating video 3 is formed between the housing 106 and the retroreflector 2 so as to protrude from the beam splitter 101 to the front side (Y direction) and stand in the vertical direction (X-Z plane).

The air floating video 3 is formed between the housing 106 and the retroreflector 2 so as to protrude from the beam splitter 101 to the front side (Y direction) and stand in the vertical direction (X-Z plane). The housing 106 of the air floating video display apparatus is not limited to being arranged at the lowermost position. Depending on the situation, the positional relationship between the housing 106 and the retroreflector 2 may be reversed, and they may be arranged side-to-side instead In other words, the beam splitter 101 is of top-to-bottom. arranged between the light emission side of the housing 106 and the retroreflector 2, the light emission side of the housing 106 and the light incident/emission side of the retroreflector 2 are arranged so as to face each other, and the beam splitter 101 is arranged obliquely with respect to the light incident/emission surface of the retroreflector 2.

The frame 108 is a member that supports the beam splitter 101, the retroreflector 2, and the λ/4 plate 21. The frame 108 extends upward from two corners of an upper surface of the housing 106, extends obliquely upward along two inclined sides of the beam splitter 101, bends in a horizontal direction (Y direction), extends along two sides of the retroreflector 2 and others, and then extends in an X direction to be closed at its ends.

In this implementation example, the components of the video display apparatus 1 illustrated in FIG. 6, that is, the light source apparatus 13, the liquid crystal display panel 11 which is a liquid crystal display element, the absorption-type polarization plate 12, and others are stored and fixed in the housing 106. An opening 1061 is provided in an upper part of the housing 106. The opening 1061 is a portion through which the video light passes. A transparent member or the like may be used for the opening 1061. The video light corresponding to the video displayed on the video display apparatus 1, more specifically, on the liquid crystal display panel 11 passes through this opening 1061 and travels upward toward the beam splitter 101.

FIG. 7 is a perspective view illustrating an appearance in a case where the air floating video display apparatus is viewed from an upper side (from diagonally above). Here, the front side of the apparatus is defined as a surface corresponding to a direction in which the user can visually recognize the air floating video 3 (indicated by dashed line frame) formed by the air floating video display 400 from the front side. A direction F is the direction in which the user visually recognizes the air floating video 3 from the front side and corresponds to the negative Y direction.

For description, a coordinate system and a direction such as (X, Y, Z) illustrated in the drawings are used in some cases. The Z direction is a vertical direction, that is, an up-down direction (vertical direction in the screen of the air floating video 3), and the X direction and the Y direction are two horizontal directions. Specifically, the X direction is a right-left direction (horizontal direction in the screen of the air floating video 3), and the Y direction is a depth direction, that is, a front-back direction (direction in which the user views the air floating video 3).

In this implementation example, as illustrated in the drawing, the air floating video display 400 has the configuration in which the beam splitter 101, the retroreflector 2, and the like are arranged so as to be exposed without being covered with the housing. Further, the housing 106 is relatively small (compact) and has a thin shape with a small thickness in the Z direction. In this implementation example, the air floating video display 400 is arranged and fixed so as to support the beam splitter 101, the retroreflector 2, and the like on the upper side of the housing 106 via the frame 108 serving as a support column. Accordingly, in the case where the air floating video display 400 (in particular, air floating video 3) is viewed from a viewpoint of the user in the Y direction, that is, from the front side (direction F), the housing in the field of view of the user is only the thin housing 106. Therefore, this implementation example is suitably used because there are few objects that obstruct the field of view of the user and it is possible to enhance the sense of floating in the air of the air floating video 3.

The thicknesses s of the beam splitter 101 and the retroreflector 2 are sufficiently thin. The main surface of the retroreflector 2 made of a resin material is arranged along the X direction and the Y direction (for example, horizontal direction). Therefore, when the air floating video 3 is visually recognized from a viewpoint of the user in the Y direction, that is, from the front side (direction F), the retroreflector 2 is not so noticeable. Furthermore, in a case where the air floating video 3 is not displayed and the air floating video display apparatus is not used, the beam splitter 101 looks like a semitransparent plate and the far side of the beam splitter 101 can be visually recognized to some extent when the air floating video display 400 is viewed from the viewpoint of the user in the Y direction (direction F).

As described above, the beam splitter 101 has a property of transmitting the P-polarized light and reflecting the S-polarized light and can be formed by, for example, depositing an optical thin film on a flat glass substrate. At this time, the incident angle of the polarized light with respect to the beam splitter 101 is generally set to about 45 degrees±15 degrees. Moreover, the video display section 300, the beam splitter 101, the retroreflector 2, and others are arranged and fixed so as to have a predetermined positional relationship, similar to the Z-shape configuration in FIG. 3.

As illustrated in FIG. 7, above the housing 106, that is, the video display section 300 or on the light emission side of the video display section 300, the beam splitter 101 is arranged via the frame 108 serving as a support column so as to form an inclined surface with respect to the X-Y plane. Further, with respect to the beam splitter 101, the retroreflector 2 and the λ/4 plate 21 are arranged on the X-Y plane via the frame 108 serving as a support column. Here, two or three sides of a rectangular main surface of each of the beam splitter 101 and the retroreflector 2 are bonded and fixed to the corresponding frame 108 serving as a support column. Then, as illustrated in the drawing, the air floating video 3 is formed at a predetermined position on the front side of the beam splitter 101 in the Y direction.

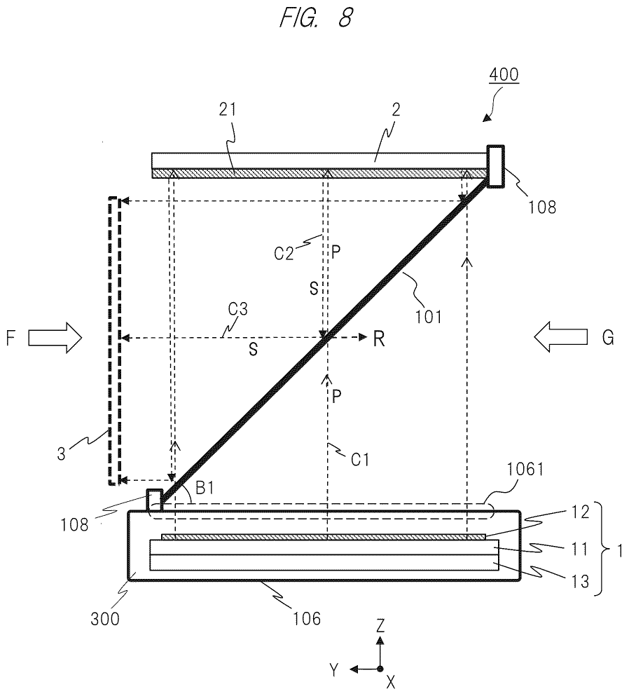

FIG. 8 is a cross-sectional view illustrating an internal structure of the video display section 300 and the air floating video display 400 in FIG. 7 viewed from a side surface in the X direction (direction E in FIG. 7). As illustrated in the drawing, the video display section 300 and the air floating video display 400 have the Z-shape configuration in FIG. 3. In a case where the configuration in FIG. 3 is rotated in the drawing such that a direction D in FIG. 3 is set to be the vertical direction (Z direction), the configuration in FIG. 3 is similar to the configuration in FIG. 8, except for the transparent member 100 and the absorption-type polarization plate 112.

In FIG. 8, the video display section 300, that is, the housing 106 and the video display apparatus 1 stored in the housing 106 are arranged in such a direction that the video light from the liquid crystal display panel 11 is emitted upward in the Z direction. Namely, the video display surface of the liquid crystal display panel 11 is arranged on an X-Y plane (horizontal plane). Also, in the housing 106, the light source apparatus 13, the liquid crystal display panel 11, and the absorption-type polarization plate 12 are arranged in this order from the bottom. In FIG. 8, the video light emitted from the video display apparatus 1 upward on an optical axis C1 via the opening 1061 is indicated by a dashed line arrow. The center dashed line arrow of the three dashed line arrows indicates an optical axis, and dashed line arrows on the left and right sides indicate a range of a light flux.

The video light emitted from the liquid crystal display panel 11 is assumed as a light having predetermined polarization characteristics, for example, P polarization (parallel polarization: P is abbreviation of Parallel). The video light of the P polarization directly passes through the beam splitter 101 upward, and travels toward the retroreflector 2 on an optical axis C2 corresponding to the optical axis C1. The beam splitter 101 has a property of transmitting the video light of P polarization and reflecting the video light of S polarization (vertical polarization: S is abbreviation of Senkrecht). The beam splitter 101 is arranged so as to form an angle of, for example, about 45 degrees with the video light of P polarization (optical axis C1, Z direction). Namely, the beam splitter 101 is arranged such that the main surface forms an angle of about 45 degrees with respect to the Y direction of the main surfaces of the liquid crystal display panel 11 and the retroreflector 2.

On the other hand, the λ/4 plate 21 is provided on the light incident surface of the retroreflector 2. The video light of P polarization on the optical axis C2 that has been emitted from the video display apparatus 1 and has passed through the beam splitter 101 is subjected to polarization conversion from the P polarization into the S polarization, by passing through the λ/4 plate 21 twice in total before being reflected by the retroreflector 2 and after being reflected by the retroreflector 2. As a result, the video light of S polarization that has traveled on the optical axis C2 after being reflected by the retroreflector 2 is reflected by the beam splitter 101, and travels on an optical axis C3 in the Y direction. This video light of S polarization generates and displays the air floating video 3 that is a real image, at a predetermined position on the front side in the Y direction as illustrated in the drawing.

The predetermined position where the air floating video 3 is formed is determined based on the optical distance of the optical path of the optical system including the video display apparatus 1, the beam splitter 101, and the retroreflector 2. In this implementation example, the position where the air floating video 3 is formed is set to a position near an end portion of a region of the main surface of the retroreflector 2 on the front side in the depth direction (Y direction). The predetermined position is adjustable by design. As described above, in this implementation example, the air floating video 3 is generated by the linearly polarized video light (video light of S polarization in this implementation example). The user (observer who observes the air floating video 3) can favorably visually recognize the air floating video 3 from the front side in the Y direction, that is, from the direction F indicated by an arrow.

In the example described above, the video display apparatus 1, the beam splitter 101, and the retroreflector 2 maintain the Z-shape positional relationship as illustrated in FIG. 8, and can provide the air floating video 3 with good visibility to the user (observer). The air floating video display apparatus according to the implementation example described above can be favorably used in a state of being installed on a horizontal surface of a desk, a table, a shelf, or the like.

Note that, when the beam splitter 101 is arranged so as to form an angle of about 45 degrees with respect to the video light of P polarization (optical axis C1, Z direction), the video displayed on the video display apparatus 1, that is, the liquid crystal display panel 11 is generated and displayed as the air floating video 3 while keeping the aspect ratio thereof. More specifically, when a perfect circle is displayed on the liquid crystal display panel 11, a perfect circle is similarly displayed as the air floating video 3.

### Second Implementation Example

Here, in a case where the air floating video display 400 is viewed from a viewpoint of a user (observer) in the Y direction (horizontal direction), that is, from the direction F in FIG. 8, when using the air floating video display apparatus of the first implementation example described above, the beam splitter 101 looks like a semitransparent plate. Therefore, the user can visually recognize the state on the far side of the beam splitter 101 (opposite side of the beam splitter 101 when viewed from the user) to some extent while observing the air floating video 3. Conversely, this means that the state on the user side can also be visually recognized to some extent through the beam splitter 101 from the far side of the beam splitter 101, that is, from the opposite side of the beam splitter 101 when viewed from the user, that is, from a direction G in FIG. 8. However, the air floating video 3 itself that is a real image cannot be visually recognized from the direction G.

As described above, the beam splitter 101 has a property of transmitting the P-polarized light and reflecting the S-polarized light and can be formed by, for example, depositing an optical thin film on a flat glass substrate. Therefore, when video light (here, P-polarized video light emitted from the liquid crystal display panel 11 constituting the video display apparatus 1) is irradiated onto the surface of the beam splitter 101, most of the light passes through the beam splitter 101, while at least a part of the light irradiated onto the beam splitter 101 is visually recognized as reflected light on the beam splitter 101.

Namely, when the video light on the optical axis C1 emitted from the video display apparatus 1 is irradiated onto the beam splitter 101 in FIG. 8, most of the video light (approximately 90% or more) passes through the beam splitter 101 and reaches the retroreflection sheet 2, while a part of the video light (approximately 5 to 10%) is reflected on the beam splitter 101. This reflected light is illustrated as reflected video light R.

In other words, when the air floating video display 400 is observed from the direction G opposite to the original direction F of the viewpoint of the user in FIG. 8, there is a problem that the video light reflected on the beam splitter 101 (reflected video light R in FIG. 8) can be seen. This reflected video light R can be visually recognized more clearly when the brightness of the surroundings of the air floating video display 400 is low, that is, when the room is dark.

A solution to this problem, that is, a method of making the reflected video light R invisible from the direction G in FIG. 8 or reducing the luminance of the reflected video light R will be described below.

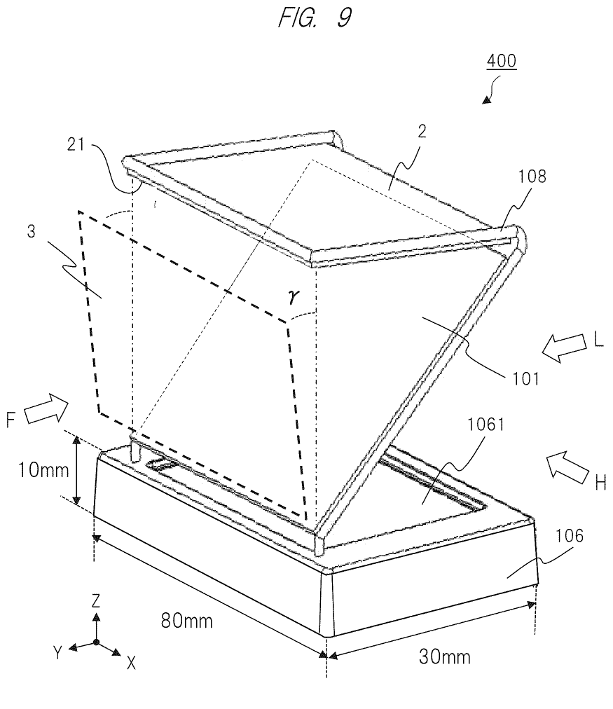

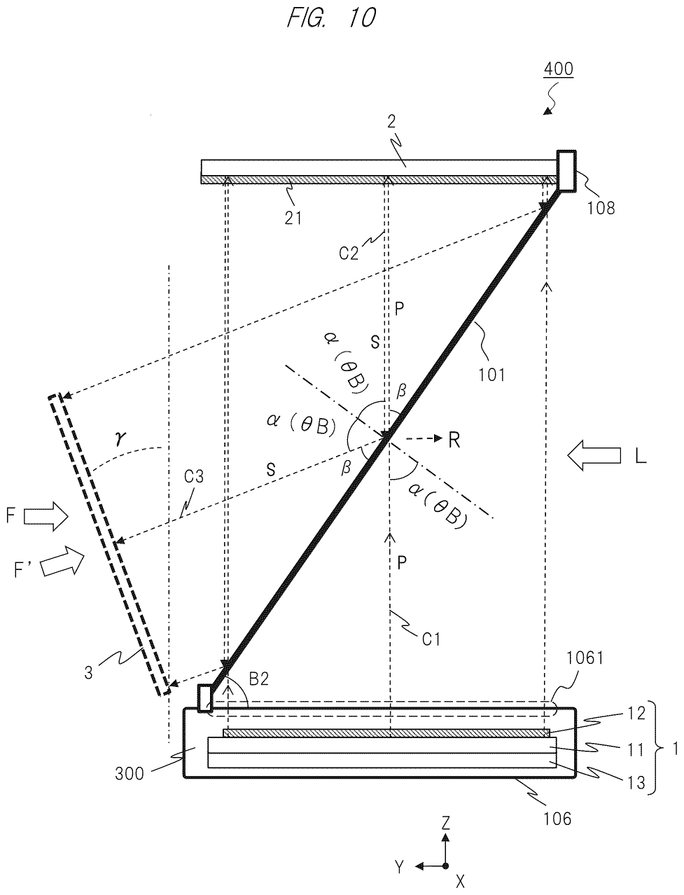

FIG. 9 and FIG. 10 illustrate an implementation example in which the air floating video display 400 illustrated in FIG. 7 and FIG. 8 is modified to be more vertically elongated in order to solve the above problem, and FIG. 9 is a perspective view of an appearance in a case where the air floating video display apparatus is viewed from an upper side (from diagonally above). The overall height of the apparatus in the Z direction in FIG. 9 is larger than the overall height of the apparatus in the Z direction in FIG. 7. An arrangement angle B2 of the inclined surface of the beam splitter 101 in FIG. 10 is larger than an angle B1 (about 45 degrees) in FIG. 8. As in FIG. 7, the front side of the apparatus here is defined as the surface corresponding to the direction F in which the user can visually recognize the air floating video 3 (indicated by dashed frame) formed by the air floating video display 400 from approximately the front side. In FIG. 9, the Z direction is the vertical direction, the X direction and the Y direction are two horizontal directions, the X direction is the left-right direction (the horizontal direction in the screen of the air floating video 3), and the Y direction is the depth direction and the front-back direction (the direction in which the user views the air floating video 3).

As in FIG. 7, above the housing 106, that is, the video display section 300, the beam splitter 101 is arranged so as to form an inclined surface with respect to the X-Y plane (horizontal plane) via the frame 108 serving as a support column. Further, with respect to the beam splitter 101, the retroreflector 2 and the λ/4 plate 21 are arranged on the X-Y plane via the frame 108 serving as a support column. Here, two or three sides of a rectangle of each of the beam splitter 101 and the retroreflector 2 are bonded and fixed to the corresponding frame 108 serving as a support column. Then, as illustrated in the drawing, the air floating video 3 is formed at a predetermined position on the front side of the beam splitter 101 in the Y direction such that an upper portion of the air floating video 3 is slightly inclined toward the front side of the user. In other words, the air floating video 3 is formed such that the upper portion of the air floating video 3 in the

Z direction is inclined toward the user more than the lower portion thereof. As illustrated in the drawing, two sides of the air floating video 3 extending in the Z direction are inclined at a predetermined angle γ with respect to the Z direction (vertical direction).

FIG. 10 is a schematic diagram of the air floating video display apparatus illustrated in FIG. 9 viewed from the side, that is, in the X-axis direction or in a direction H in FIG. 9. In addition, in FIG. 10, the above-mentioned direction F is also defined as the negative Y direction, and a direction F′ is illustrated as an oblique direction when the air floating video 3 formed slightly obliquely is visually recognized from the front side (direction perpendicular to the surface).

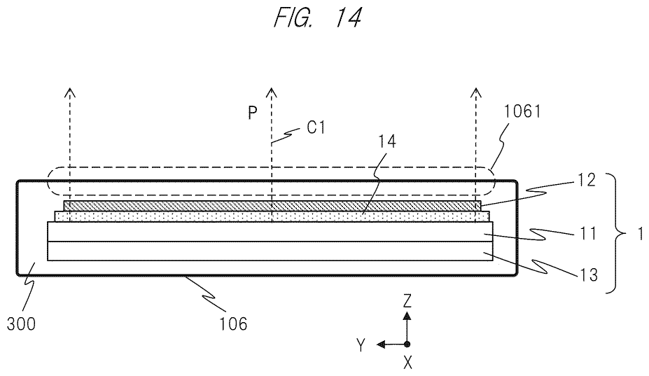

In FIG. 10, the video light emitted from the liquid crystal display panel 11 is generally linearly polarized light (S-polarized light or P-polarized light). In the implementation example of FIG. 10, the video light emitted from the liquid crystal display panel 11 is P-polarized video light. In this implementation example, if the video light emitted from the liquid crystal display panel 11 is P-polarized light, the video light can be emitted to the beam splitter 101 as it is so as to transmit the video light through the beam splitter 101. On the other hand, if the video light emitted from the liquid crystal display panel 11 is S-polarized light, the S-polarized video light is transmitted through the λ/2 plate 14 (FIG. 14) in order to convert it into P-polarized light.

FIG. 14 illustrates an arrangement example of the λ/2 plate 14 in one implementation example (modification of the second implementation example) in which the video light emitted from the liquid crystal display panel 11 is S-polarized light. This λ/2 plate 14 is an element different from the λ/4 plate 21 of the retroreflector 2, and is a polarization conversion element, a retardation plate, or a half-wave plate that converts S-polarized light into P-polarized light. Here, the liquid crystal display panel 11 and the λ/2 plate 14 are arranged at, for example, positions in the housing 106 illustrated in the drawing together with the light source apparatus 13 and the absorption-type polarization plate 12. In FIG. 14, the λ/2 plate 14 is provided on the upper side of the liquid crystal display panel 11 in the

Z direction so as to be in contact with the video light emission surface of the liquid crystal display panel 11, and the absorption-type polarization plate 12 is provided in contact with the upper side of the λ/2 plate 14.

As another configuration example different from the example in FIG. 14, the λ/2 plate 14 may be provided on the lower surface of a transparent member in the opening 1061 of the housing 106.

The video light as P-polarized light from the liquid crystal display panel 11 in FIG. 10 or the video light converted into P-polarized light by the λ/2 plate 14 (P-polarized video light) in FIG. 14 passes through the beam splitter 101 in FIG. 10 and enters the retroreflector 2 via the λ/4 plate 21. At this time, the video light that has entered the retroreflector 2 passes through the λ/2 plate 21 twice when entering the retroreflector 2 and when reflected by the retroreflector 2, and is therefore converted into S-polarized video light. The video light reflected by the retroreflector 2 is converted into S-polarized video light as described above, and is therefore reflected by the beam splitter 101. As a result, the air floating video 3 is generated at the position illustrated in FIG. 10.

At this time, the video light as P-polarized from the liquid crystal display panel 11 and the video light that has passed through the above-mentioned λ/2 plate 14 and been converted into P-polarized are different in the rate of reflection (reflectance) on the beam splitter 101 in FIG. 10 depending on the incident angle α on the beam splitter 101 when entering the beam splitter 101.

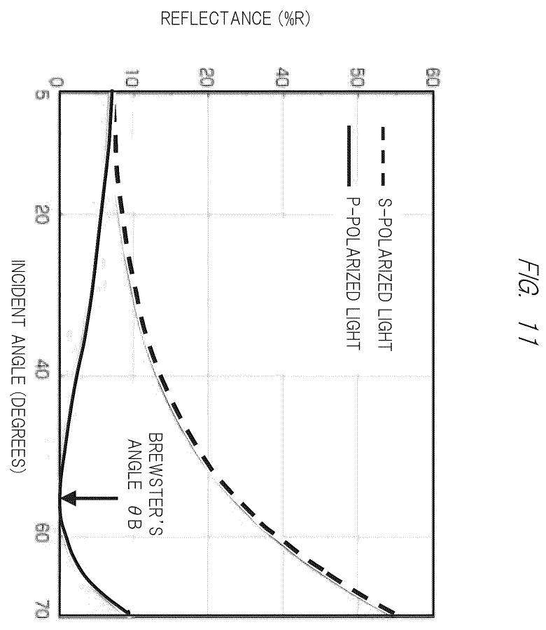

The graph illustrated in FIG. 11 represents the incident angle and the reflectance (% R) on the glass surface when S-polarized light and P-polarized light are made to enter the glass with a refractive index n=1.5 from the air. In FIG. 11, a dashed curve indicates the change in reflectance relative to the change in the incident angle of S-polarized video light, and a solid curve indicates the change in reflectance relative to the change in the incident angle of P-polarized video light. As illustrated in FIG. 11, S-polarized video light has the relationship of the monotonic increase in which the reflectance increases as the incident angle increases, whereas P-polarized video light has the relationship in which the reflectance approaches 0 as the incident angle increases, the reflectance becomes 0 at a certain angle, and the reflectance increases again as the incident angle further increases. Furthermore, at the same incident angle, the reflectance of S-polarized video light is always larger than the reflectance of P-polarized video light.

As illustrated in FIG. 11, the incident angle at which the reflectance of P-polarized video light becomes 0 is referred to as Brewster's angle (denoted as θB). The Brewster's angle θB is determined by the following formula 1 based on the refractive indices of two substances (here, air and glass).

$$θ B = arctan ( n 2 / n 1 ) \qquad ( Formula 1 )$$

In Formula 1, n1 is the refractive index on the incident side (that is, air) and n2 is the refractive index on the transmission side (that is, glass). For example, the Brewster's angle θB of light incident on glass with a refractive index of 1.5 from air with a refractive index of 1 is 56.3 degrees.

As is clear from FIG. 11, reflection occurs constantly in the case of S-polarized video light even if the incident angle is changed, whereas P-polarized video light enters the substance (glass) and is no longer reflected when the incident angle becomes the Brewster's angle θB. In other words, the reflectance (% R) has the property of being zero at the Brewster's angle θB. On the other hand, as is clear from Formula 1, the Brewster's angle changes depending on the refractive index of the incident substance, and the Brewster's angle increases as the refractive index on the transmission side is larger relative to that on the incident side.

As described above, in the case of the configuration in which P-polarized video light is incident on the beam splitter 101 at the Brewster's angle calculated using Equation 1 based on the refractive index (n2) on the transmission side according to the substance of the beam splitter 101, there will be no reflection on the beam splitter 101. As already mentioned, since the beam splitter 101 is formed, for example, as an optical thin film on flat glass, the Brewster's angle θB of the beam splitter 101 is the same value (56.3 degrees) as the Brewster's angle θB of glass (more specifically, quartz glass).

As a result, in the case of the configuration in which the P-polarized video light emitted from the video display apparatus 1 based on the video light from the liquid crystal display panel 11 is incident on the beam splitter 101 at the Brewster's angle θB in FIG. 10, the reflected video light R reflected on the beam splitter 101 will be approximately zero. The reflected video light R cannot be visually recognized from the direction opposite to the direction in which the air floating video 3 is formed, specifically, from a direction L in FIG. 10. In this way, it is possible to achieve the effect of making it difficult for others to see the video light that may be bothersome to those other than the user of the air floating video display apparatus and the effect for the user of being able to prevent others from seeing the video light that the user does not want others to see.

Furthermore, as is clear from the graph illustrated in FIG. 11, simply when the incident angle α of the video light on the beam splitter 101 is set to the Brewster's angle θB (56.3 degrees) or a somewhat smaller angle close to the Brewster's angle θB (for example, an angle in the range of 50 degrees to less than 56.3 degrees) (θB>α≥50 degrees), although it is not possible to completely reduce the reflected video light R to zero, the reflectance of the video light on the beam splitter 101 can be reduced to 2% or less, and the reflected video light R can be reduced to a nearly unrecognizable level. Furthermore, even if the incident angle α on the beam splitter 101 is an angle away from the Brewster's angle θB (for example, α<50 degrees), as can be seen from the graph illustrated in FIG. 11, the luminance of the reflected video light R can be reduced simply by converting the video light incident on the beam splitter 101 from S-polarized light to P-polarized light using, for example, the λ/2 plate 14.

As described above, the incident angle α when the video light emitted from the video display apparatus 1 enters the beam splitter 101 on the optical axis C1 is set to be the Brewster's angle θB (specifically, 56.3 degrees) or an angle within a range close to the Brewster's angle θB (θB>α≥50 degrees). Namely, the arrangement angle of each component is defined as illustrated in FIG. 10. FIG. 10 illustrates an example of α=θB. In particular, the arrangement angle of the inclined surface of the beam splitter 101 is an angle β (β=90 degrees−θB=33.7 degrees) with respect to the Z direction (vertical direction) and is an angle B2 (B2=θB=56.3 degrees) with respect to the horizontal plane (Y direction).

In this way, the reflected video light R of the video light on the beam splitter 101 can be reduced to zero or approximately zero or to a level that does not pose a problem in practical use. In other words, when the beam splitter 101 is viewed from the opposite side (direction L) to the side where the air floating video 3 can be visually recognized, the reflected video light R can be reduced to a visually unrecognizable level.

The specific incident angle α when entering the beam splitter 101 is not limited to the Brewster's angle θB described above, and an effect similar to that of the above implementation example can be obtained if it is set to an angle within the range of 45 degrees to 60 degrees.

### Modification (Third Implementation Example)

Here, when the incident angle on the beam splitter 101 is set to Brewster's angle, a new problem described below arises. As illustrated in FIG. 8, in the case of the configuration in which the beam splitter 101 is arranged so as to form an angle of about 45 degrees with respect to the P-polarized video light (optical axis C1, Z direction), while the video displayed on the video display apparatus 1, that is, on the liquid crystal display panel 11 keeps the aspect ratio thereof, the air floating video 3 is generated and displayed in the direction F corresponding to the expected direction of the user's line of sight, that is, the horizontal direction (Y direction).

On the other hand, as illustrated in FIG. 10, in the configuration in which the incident angle α of the P-polarized video light on the beam splitter 101 is set to Brewster's angle θB of 56.3 degrees, the air floating video 3 is generated in a diagonally downward direction (corresponding to direction F′) as viewed from the user (direction F). In FIG. 10, the S-polarized video light from the beam splitter 101 is reflected on the optical axis C3 having an angle corresponding to (θB×2) with respect to the vertical direction (Z direction) as illustrated in the drawing. Therefore, the plane of the air floating video 3 is arranged as a plane perpendicular to the direction of the optical axis C3, in other words, as a plane inclined at a predetermined angle γ (angle determined in relation to θB and β) with respect to the X-Z plane and having an upper side inclined downward.

In the case of this configuration, not only does the visibility deteriorate when a user views the air floating video 3 from the direction F, but also a new problem arises in that the air floating video 3 cannot be visually recognized depending on the position of the user's eyes.

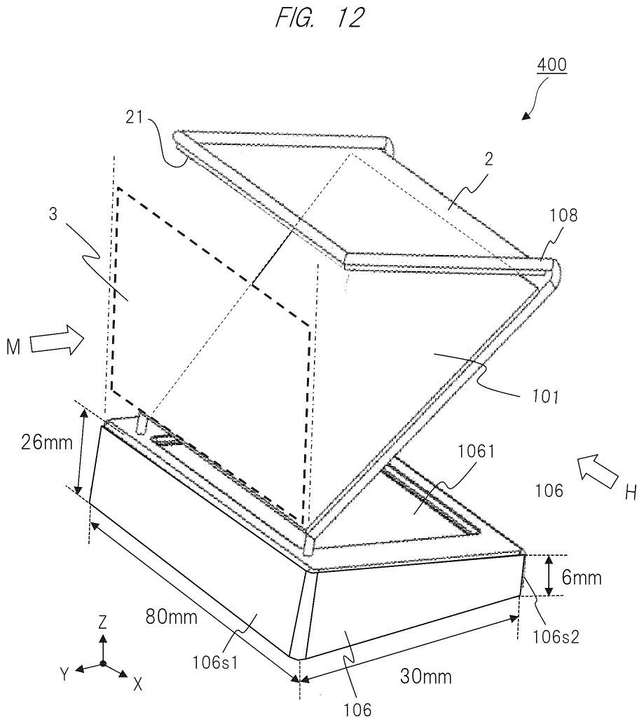

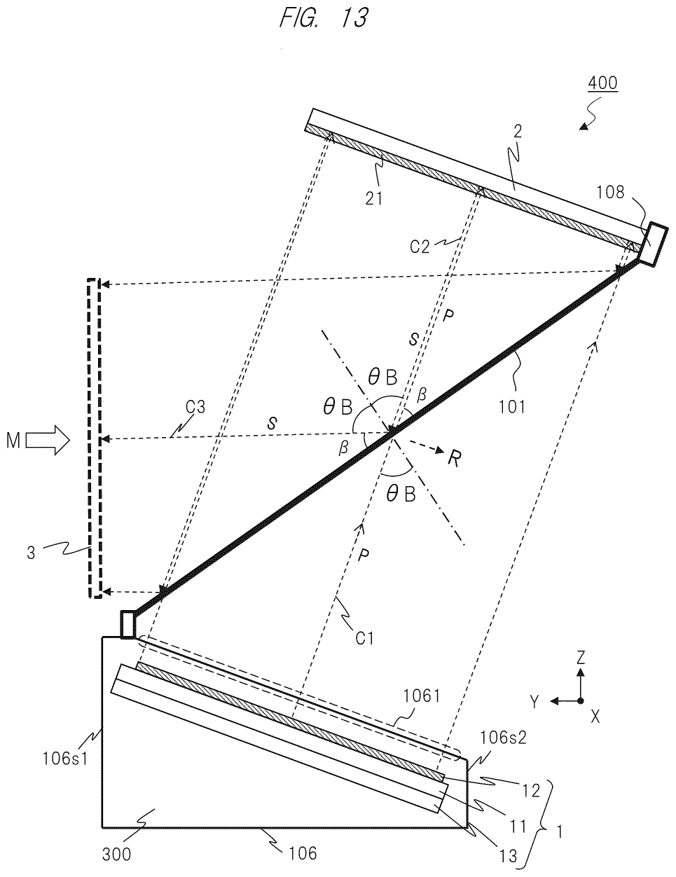

Thus, FIG. 12 and FIG. 13 illustrate an implementation example corresponding to the means for solving the above- mentioned problem of the visibility deterioration and others. FIG. 12 similarly illustrates a perspective view of the air floating video display apparatus in this implementation example. In FIG. 12, the housing 106 is modified such that the air floating video 3 coincides with the X-Z plane. Specifically, a height of a surface 106s1 on a front side in the Y direction corresponding to the side of the housing 106 where the air floating video 3 is formed is made larger than that in the case of FIG. 9, and a height of a surface 106s2 on a back side opposite to the side where the air floating video 3 is formed is made smaller. The height of the housing 106 in the Z direction is 10 mm, the width in the X direction is 80 mm, and the depth in the Y direction is 30 mm in the example of FIG. 9, whereas the height of the surface 106s1 is 26 mm and the height of the surface 106s2 is 6 mm in FIG. 12. As a result, the difference in height between the front side and the back side is 20 mm in FIG. 12. On the other hand, the depth between the front side and the back side remains the same at 30 mm. Consequently, the air floating video display 400 in FIG. 12 is arranged so as to be inclined backward at an angle of arctan(20/30), that is, 33.7 degrees as a whole. This 33.7 degrees corresponds to the angle B which is the difference between 90 degrees and the Brewster's angle θB of 56.3 degrees. Alternatively, the angle formed between the light emission surface of the liquid crystal display panel and the light incident surface of the retroreflector 2 corresponds to the difference between 90 degrees and the Brewster's angle θB.

FIG. 13 illustrates a cross-section viewed from the direction H in FIG. 12. In FIG. 12 and FIG. 13, the upper surface of the housing 106 which has different heights on the front and back surfaces is inclined with respect to the X-Y plane, and the air floating video display 400 is arranged above the upper surface in the same positional relationship as that in FIG. 9 and FIG. 10. When the light emission surface of the video display apparatus 1 is arranged along the upper surface of the housing 106, the video display apparatus 1 is obliquely arranged in the housing 106 so as to form a Z shape with respect to the beam splitter 101 and the retroreflector 2. In other words, the light emission surface of the video display apparatus 1 or the surface of the liquid crystal display panel is arranged obliquely, or the distance between the emission surface of the video display apparatus 1 on the side of the housing 106 connected to the beam splitter 101 and the retroreflector 2 is shorter than the distance between the emission surface of the video display apparatus 1 on the side of the housing 106 that is not connected to the beam splitter 101 and the retroreflector 2. Alternatively, the light emission surface of the video display apparatus 1 or the light emission surface of the liquid crystal display panel has a shorter distance from the retroreflector 2 on the side corresponding to the formed air floating video than on the side opposite to the air floating video.

Therefore, with the configuration of FIG. 12, the plane on which the air floating video 3 is formed coincides with the X-Z plane. In the case of viewing in the direction of the user's line of sight (direction M corresponding to the negative Y direction in FIG. 12), the air floating video 3 is most visible to the user at high brightness, and has the same aspect ratio as the original aspect ratio (the same aspect ratio as that of the video displayed on the liquid crystal display panel 11).

As described above, when the incident angle of the P-polarized video light displayed on the liquid crystal display panel 11 on the beam splitter 101 is the Brewster's angle θB of 56.3 degrees, the air floating video 3 is generated in an obliquely downward direction as illustrated in FIG. 9, so that the visibility is deteriorated for the user. Thus, as illustrated in FIG. 12, by making the front side of the housing 106 including the video display apparatus 1 higher and the back side thereof lower, the plane on which the air floating video 3 is formed can be made to coincide with the X-Z plane. This makes it possible to optimize the visibility of the air floating video 3 for favorable use.

### Effects and Others

As described above, with the air floating video display apparatus according to each implementation example and modification, it is possible to display an air floating video mainly suitable for indoor use and having high visibility. Furthermore, it is possible to provide the air floating video display apparatus in which the luminance of the reflected video light caused by the reflection of the video light from the video display apparatus 1 based on the video light from the liquid crystal display panel 11 on the beam splitter 101 can be made zero or reduced. As a result, it is possible to make the reflected video light invisible to the person who is located on the opposite side of the air floating video display apparatus when viewed from the user located at the position capable of observing the air floating video. In a room or the like where the air floating video display apparatus is installed, an effect of making it difficult to see the video light that may be unnecessary or bothersome to people other than the user can be achieved.

Furthermore, in order to make the luminance of the reflected video light zero or reduce it, the incident angle of the video light on the beam splitter 101 needs to be increased from 45 degrees to the Brewster's angle θB of 56.3 degrees, but in this case, the air floating video is inclined downward as viewed from the user and the problem of the visibility deterioration arises. For this problem, by appropriately adjusting the height of the front side and the back side of the housing 106 that stores the video display apparatus 1, the plane on which the air floating video 3 is formed can be made to be a vertical plane and the effect of optimizing the visibility can be achieved.

Due to the above effects, the air floating video display apparatus according to each implementation example and modification can display bright air floating video having high visibility without emitting video light that is unnecessary for people other than the user even when used in a relatively narrow room, and the air floating video display apparatus can be easily installed indoors, for example, on a desk, a table, or a shelf because of its compact size and lightweight.

In the technique according to the implementation examples, by displaying video information as a high-resolution and high-brightness air floating video in the air floating state, the air floating video can also be used as a non-contact user interface, and the user can operate without feeling anxious about contact infection of infectious diseases. In this way, it is possible to contribute to “Goal 3: Ensure healthy lives and promote well-being for all at all ages” in the Sustainable Development Goals (SDGs) advocated by the United Nations.

In addition, in the technique according to the implementation examples, only normal reflected light is by efficiently reflected with respect to the retroreflector making the divergence angle of the emitted video light small and aligning the light with a specific polarized wave (polarization), and thus a bright and clear air floating video can be obtained with high light utilization efficiency. With the technique according to the implementation examples, it is possible to provide a highly usable non-contact user interface capable of significantly reducing power consumption. In this way, it is possible to contribute to “Goal 9: Build resilient infrastructure, promote inclusive and sustainable industrialization and foster innovation” in the Sustainable Development Goals (SDGs) advocated by the United Nations.

In the foregoing, the embodiment of this disclosure has been specifically described, but this disclosure is not limited to the embodiment described above, and various modifications can be made within the range not departing from the gist thereof. Each component may be singular or plural unless particularly limited. The components of the respective implementation examples can be added, deleted, replaced, or the like, except for essential components. A mode in which the implementation examples are combined is also possible.

### REFERENCE SIGNS LIST

1: video display apparatus, 2: retroreflector, 3: air floating video, 11: liquid crystal display panel, 12, 112: absorption-type polarization plate, 13: light source apparatus, 21: λ/4 plate, 100: transparent member, 101: beam splitter (polarization separation member), 106: housing, 108: frame, 300: video display section, 400: air floating video display, 1061: opening

1. An air floating video display apparatus configured to display an air floating video, the air floating video display apparatus comprising:
a housing configured to store a video display apparatus;
a retroreflector arranged outside the housing so as to face the video display apparatus and having a λ/4 plate provided on a retroreflection surface; and
a polarization separation member arranged at a predetermined angle with respect to the video display apparatus and the retroreflector, in a space connecting the video display apparatus and the retroreflector outside the housing,
wherein the video display apparatus includes a light source apparatus and a liquid crystal display panel as a video source, and
wherein a video light of a specific polarized wave emitted from the liquid crystal display panel enters the polarization separation member at a specific incident angle, passes through the polarization separation member, is reflected by the retroreflector, and passes through the λ/4 plate to be subjected to polarization conversion into a video light of the other polarized wave, the video light of the other polarized wave is reflected by the polarization separation member, and the air floating video that is a real image is displayed at a predetermined position based on the reflected video light.

2. The air floating video display apparatus according to claim 1,
wherein the video light of the specific polarized wave that enters the polarization separation member is P-polarized light.

3. The air floating video display apparatus according to claim 1,
wherein the specific incident angle at which the video light enters the polarization separation member is an angle within a range of 45 degrees or more to 60 degrees or less.

4. The air floating video display apparatus according to claim 1,
wherein the specific incident angle at which the video light enters the polarization separation member is Brewster's angle depending on a substance of the polarization separation member or an angle within a range of 50 degrees to less than the Brewster's angle.

5. The air floating video display apparatus according to claim 4,
wherein a height of a surface on a front side of the housing in which the video display apparatus is stored corresponding to a side where the air floating video is formed is made larger than a height of a surface on a back side such that a plane on which the formed air floating video is displayed is made to be a vertical plane.

6. The air floating video display apparatus according to claim 1,
wherein the polarization separation member and the retroreflector are supported by a frame with respect to the housing in which the video display apparatus is stored.

7. The air floating video display apparatus according to claim 1,
wherein, in the polarization separation member, a reflection-type polarization plate or a metal multilayer film that reflects the specific polarized wave is formed as an optical thin film on a glass substrate.

8. The air floating video display apparatus according to claim 1,
wherein a surface roughness of the retroreflection surface of the retroreflector is set such that a ratio between a blur amount of the air floating video and a pixel size of the video display apparatus is equal to or less than 40%,
wherein the light source apparatus includes:
a point-like or planar light source;
an optical element configured to reduce a divergence angle of light from the light source;
a polarization converter configured to align the light from the light source to polarization of a specific direction; and
a light guide body having a reflection surface configured to propagate the light from the light source to the liquid crystal display panel, and
wherein a video light flux of the video light from the liquid crystal display panel is controlled based on a shape and a surface roughness of the reflection surface.

9. The air floating video display apparatus according to claim 2,
wherein the video light from the liquid crystal display panel is S-polarized light,
the air floating video display apparatus further comprising a λ/2 plate configured to convert the S-polarized video light from the liquid crystal display panel into the P-polarized light for entering the polarization separation member.
